(19) United States
(12) Patent Application Publication
(10) Pub. No.: US 2008/0288680 A1
(43) Pub. Date: Nov. 20, 2008

(54) COMMUNICATION ARRANGEMENT

(75) Inventors: Axel Lohbeck, Minden (DE); Wolfgang Jantzen, Minden (DE); Gerd Dewitz, Bad Salzuflen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/107,881

(22) Filed: Apr. 23, 2008

(30) Foreign Application Priority Data
Apr. 23, 2007 (DE) 10 2007 019 047.8

(51) Int. Cl. G06F 13/00

(52) U.S. Cl. 710/100

(57) ABSTRACT

The disclosure relates to an arrangement and method for communication between modular devices for measurement, closed-loop and open-loop control which are connected to one another via a backplane. It is proposed that two modules of the device in each case be connected to one another via a serial point-to-point connection. Modules with a coupling element are connected to a plurality of other modules.

### RELATED APPLICATION

This application claims priority under 35 U.S.C. §119 to German Patent Application No. 10 2007 019 047.8 filed in Germany on Apr. 23, 2007, the entire content of which is hereby incorporated by reference in its entirety.

### TECHNICAL FIELD

A method and arrangement are disclosed for communication between modular devices for measurement, closed-loop and open-loop control.

### BACKGROUND INFORMATION

DE 42 38 957 discloses a modular device whose modules are connected to one another for communication purposes by means of a plurality of serial lateral buses, which are routed in parallel, and are in the form of CAN buses.

The progress and the development of devices for measurement, closed-loop and open-loop control has led to increasing volumes of data, as a result of better monitoring and diagnostic functions in particular, the transport and transmission of which volumes of data within reasonable time periods overloads even multiple bus configurations, and at the same time leads to large amounts of material being required.

### SUMMARY

An arrangement for communication between modular devices for measurement is disclosed, closed-loop and open-loop control, which allows a high data throughput using little material.

A modular device for measurement is disclosed, closed-loop and open-loop control, whose modules are connected to one another by means of serial buses for communication, and which are connected to one another via a backplane.

An arrangement for communication between modular devices for measurement is disclosed, closed-loop and open-loop control, which are connected to one another via a backplane, wherein two modules of the device are in each case connected to one another via a serial point-to-point connection.

A method of arrangement is disclosed for communication between modular devices for measurement, closed-loop and open-loop control, the method comprising: connecting the modular devices for measurement, closed-loop and open-loop control to one another via a backplane, wherein two modules of a device are in each case connected to one another via a serial point-to-point connection.

### BRIEF DESCRIPTION OF THE DRAWINGS

Further details and advantages of the disclosure will be described in the following text with reference to exemplary embodiments. In the figures which are required for this purpose:

FIG. 1 shows an outline illustration of a modular device with a coupling element in a module, and simple coupling,

FIG. 2 shows an outline illustration of a modular device with redundant coupling.

### DETAILED DESCRIPTION

According to the disclosure, two modules of the device are in each case connected to one another via a serial point-to-point connection. The point-to-point connection between two respective modules actually also makes it possible to use the data rate of the respective connection protocol, since collisions resulting from other subscribers who wish to transmit on the same bus are excluded in the master-slave mode. Furthermore, there is no need for any measures for addressing the subscribers and to resolve collisions in the connection protocol.

According to a further feature of the disclosure, at least one module is connected to a plurality of serial point-to-point connections. All the modules of the modular device can therefore be connected directly to one another for communication purposes. The modules with only one serial point-to-point connection are connected directly via a module which is connected to a plurality of serial point-to-point connections.

According to a further feature of the disclosure, at least one module is equipped with a coupling element to which the serial point-to-point connections are routed. All the modules of the modular device can therefore be connected directly to one another for communication purposes. The modules with only one serial point-to-point connection are connected directly via the coupling element.

According to a further feature of the disclosure, the point-to-point connection is formed by a USB (Universal Serial Bus). In this case, the protocol of the Universal Serial Bus, which is known per se, is used for the communication-carrying bus physics. This includes, in particular differential transmission of the data via a pair of conductors between in each case two modules.

Appropriate communication circuits for operation of the USB are commercially available. Because of the widespread use of USB in the field of personal computers, these communication circuits are manufactured in large quantities, and therefore cost less than communication circuits for other less widely used bus systems. Furthermore, the software drivers for operation of the communication circuits are available for various operating systems. The complexity to implement the communication means is therefore advantageously low.

Since Version 2.0 of the USB specification, the data rate on the bus has been up to 480 Mbit/s. This allows a high data throughput between the modules.

According to a further feature of the disclosure, the point-to-point connection is formed by a serial bus in accordance with the firewire specification (IEEE 1394). In this case, the protocol of the firewire bus, which is known per se, is used for the communication-carrying bus physics. This includes, in particular, differential transmission of data via a pair of conductors between in each case two modules.

According to a further feature of the disclosure, at least one module without a coupling element is connected via in each case one serial point-to-point connection to at least two other modules which are each equipped with a coupling element. This allows individual modules, or all the modules, of the modular device to be networked redundantly in the device.

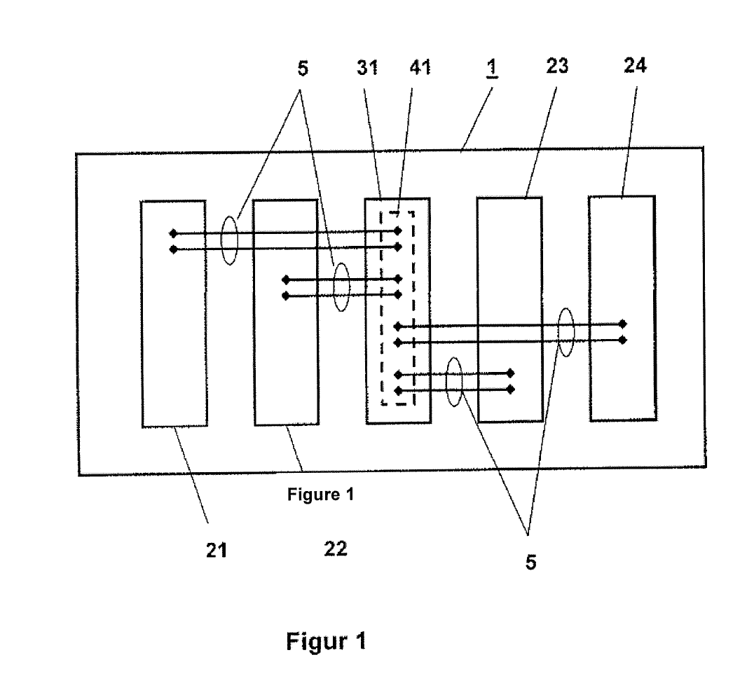

FIG. 1 shows an outline illustration of a modular device for measurement, closed-loop and open-loop control, which is accommodated in a switchgear cabinet, or in another desired housing. Plug-in slots for a plurality of modules 21 to 24 and 31 of the device are arranged on a backplane printed circuit board 1, and are in each case connected to one another in pairs by point-to-point connections 5. For this purpose, all the modules 21 to 24 and 31 of the device have at least one communication interface for connection of a point-to-point connection 5.

In this case, one module 31 is characterized by a special position, on the basis of which a plurality of serial point-to-point connections 5 are connected to this module 31. All the modules 21 to 24 and 31 of the modular device can therefore be connected directly to one another, for communication purposes. The modules 21 to 24 with only one serial point-to-point connection 5 are connected directly via a module 31, which is connected to a plurality of serial point-to-point connections 5.

In this case, it is possible for the module 31 to be a controlled module which is connected via the backplane printed circuit board 1 to a plurality of input/output modules 21 to 24. Furthermore, it is possible for the control module 31 to be connected to a high-level device, which is not illustrated. The input/output modules 21 to 24 are connected to devices which are close to the process but are not illustrated, such as sensors and actuators.

In a further refinement of the disclosure, a module 31 is equipped with a coupling element 41 to which the serial point-to-point connections 5 are routed. This coupling element 41 has a plurality of interfaces for connection of all the point-to-point connections 5 which can be connected to one another. The coupling element 41 is designed in such a way that any two desired connections of the connected point-to-point connections 5 can be connected to one another. In this case, the accommodating module 31 is not influenced by the continuous communication between two other modules 21 to 24. Coupling elements 41 such as these are known per se and are commercially available. All the modules 21 to 24 and 31 of the modular device can therefore be connected directly to one another for communication purposes. The modules 21 to 24 with only one connected serial point-to-point connection are connected directly via the coupling element 41.

In a first exemplary embodiment of the disclosure, each point-to-point connection 5 is formed by a USB (Universal Serial Bus). In this case, the protocol of the Universal Serial Bus, which is known per se, is used for communication-carrying bus physics. This includes, in particular, differential transmission of data via a pair of conductors between in each case two modules 21 to 24 and 31. Appropriate communication circuits such as a USB hub are commercially available for its operation. Because of the widespread use of USB in the field of personal computers, these communication circuits are manufactured in large quantities, and therefore cost little in comparison to communication circuits for other less widely used bus systems. Furthermore, the software drivers for operation of the communication circuits are available for various operating systems. In consequence, the complexity for implementation of the communication means is advantageously low.

In another exemplary embodiment of the disclosure, each point-to-point connection 5 is formed by a serial bus in accordance with the firewire specification (IEEE 1394). In this case, the protocol of the firewire bus, which is known per se, is used for the communication-carrying bus physics.

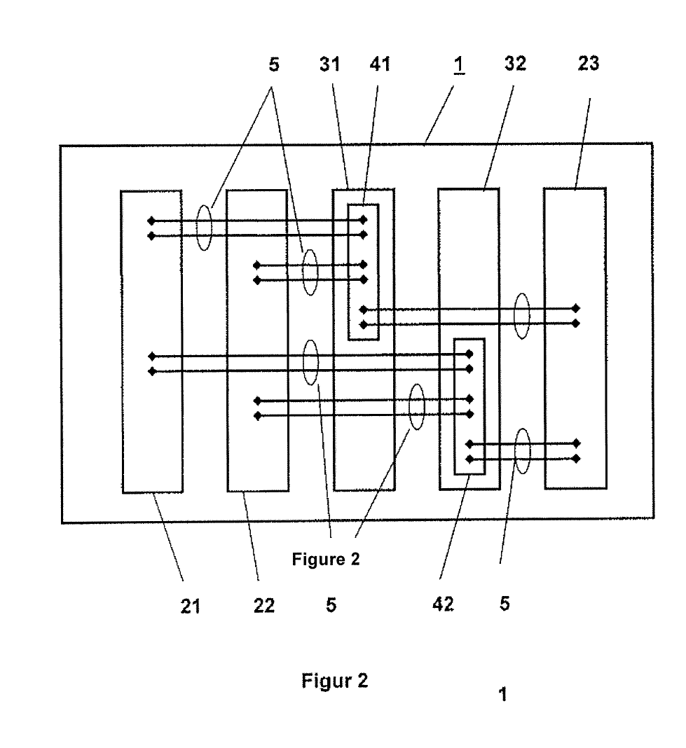

In yet another exemplary embodiment of the disclosure in FIG. 2, a modular device for measurement, closed-loop and open-loop control is illustrated in an outline form, using the same reference symbols for the same items, in which plug-in slots for a plurality of modules 21 to 23, 31 and 32 of the device are arranged on a backplane printed circuit board 1, which are each connected to one another in pairs by means of point-to-point connections 5.

In this exemplary embodiment of the disclosure, two modules 31 and 32 are each connected independently of one another to a plurality of serial point-to-point connections 5 and each equipped with a coupling element 41 and 42, to which the serial point-to-point connections 5 are connected. The modules 21 to 23 without a coupling element 41 and 42 are each connected via a serial point-to-point connection to at least two other modules 31 and 32, which are each equipped with a coupling element 41 and 42.

In yet another exemplary embodiment of the disclosure, the modules 31 and 32 with a coupling element 41 and 42 are in the form of a control module and the modules 21 to 23 without a coupling element 41 and 42 are in the form of input/output modules, redundant communication is provided between the control module and the input/output modules by means of the parallel, mutually independent connection of the modules 21 to 23

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Backplane printed circuit board
21 . . . 24, 31, 32 Module
41, 42 Coupling element
5 Point-to-point connection

What is claimed is:

1. An arrangement for communication between modular devices for measurement, closed-loop and open-loop control, which are connected to one another via a backplane, wherein
two modules of the device are in each case connected to one another via a serial point-to-point connection.

2. The arrangement as claimed in claim 1, wherein
at least one module is connected to a plurality of serial point-to-point connections.

3. The arrangement as claimed in claim 2, wherein
at least one module is equipped with a coupling element.

4. The arrangement as claimed in claim 3, wherein
at least one module without a coupling element is connected via in each case one serial point-to-point connection to at least two other modules which are each equipped with a coupling element.

5. The arrangement as claimed in claim 1, wherein
the point-to-point connection is formed by a Universal Serial Bus.

6. The arrangement as claimed in claim 1, wherein
the point-to-point connection is formed by a serial bus in accordance with a firewire specification (IEEE 1394).

7. The arrangement as claimed in claim 4, wherein
the point-to-point connection is formed by a Universal Serial Bus.

8. The arrangement as claimed in claim 4, wherein
the point-to-point connection is formed by a serial bus in accordance with a firewire specification (IEEE 1394).

9. A method of arrangement for communication between modular devices for measurement, closed-loop and open-loop control, the method comprising:
connecting the modular devices for measurement, closed-loop and open-loop control to one another via a backplane, wherein
two modules of a device are in each case connected to one another via a serial point-to-point connection.

10. The method as claimed in claim 9, wherein
at least one module is connected to a plurality of serial point-to-point connections.

11. The method as claimed in claim 10, wherein
at least one module is equipped with a coupling element.

12. The method as claimed in claim 11, wherein
at least one module without a coupling element is connected via in each case one serial point-to-point connection to at least two other modules which are each equipped with a coupling element.

13. The method as claimed in claim 9, wherein
the point-to-point connection is formed by a universal serial bus.

14. The method as claimed in claim 9, wherein
the point-to-point connection is formed by a serial bus in accordance with a firewire specification.

15. The method as claimed in claim 12, wherein
the point-to-point connection is formed by a universal serial bus.

16. The method as claimed in claim 12, wherein
the point-to-point connection is formed by a serial bus in accordance with a firewire specification.
